(19) United States
(12) Patent Application Publication
(10) Pub. No.: US 2020/0099594 A1
(43) Pub. Date: Mar. 26, 2020

(54) DEVICE FOR PROCESSING STREAM OF DIGITAL DATA, METHOD THEREOF AND COMPUTER PROGRAM PRODUCT

(71) Applicant: HUAWEI TECHNOLOGIES CO., LTD., Shenzhen (CN)

(72) Inventors: Radu TUDORAN, Munich (DE); Goetz BRASCHE, Munich (DE); Xing ZHU, Shenzhen (CN)

(21) Appl. No.: 16/698,343

(22) Filed: Nov. 27, 2019

Related U.S. Application Data
(63) Continuation of application No. PCT/EP2017/063187, filed on May 31, 2017.

(51) Int. Cl. H04L 12/24; H04L 12/26

(52) U.S. Cl. CPC H04L 41/5032; H04L 43/062; H04L 41/142; H04L 41/0836; H04L 43/50

(57) ABSTRACT

A device for processing a stream of digital data, includes a memory configured to store executable instructions, and at least one processor coupled to the memory and configured to execute the instructions to manage a plurality of stream processing engines, each of the plurality of stream processing engines having a plurality of stream processing objects and simultaneously process the stream of digital data by the plurality of stream processing engines, and during the simultaneously processing the stream of digital data, to send an output of a first stream processing object of the plurality of stream processing objects of a first stream processing engine of the plurality of stream processing engines to an input of a second stream processing object of the plurality of stream processing objects of a second stream processing engine of the plurality of stream processing engines.

### CROSS-REFERENCE TO RELATED APPLICATIONS

This application is a continuation of International Application No. PCT/EP2017/063187, filed on May 31, 2017, the disclosure of which is hereby incorporated by reference in its entirety.

### BACKGROUND

The term big data is used to refer to a collection of data so large and/or so complex that traditional data processing application software cannot adequately deal with the collection of data. Among the challenges in dealing with big data is analysis of the large amount of data in the collection.

Some solutions for processing unbound streams of data use a stream processing engine. A stream processing engine is a set of software objects, having an application programming interface (API) for describing a desired processing of a stream of data. The stream processing engine has a set of stream processing objects that are managed by the stream processing engine. A stream processing object, also referred to as an operator, is a software object for processing streamed data, having a function and at least one input and at least one output. The stream processing object produces results by applying its function to data received on the at least one input. The stream processing object outputs the results on the stream processing object's at least one output. A stream processing engine manages a plurality of connections between a plurality of its stream processing objects, where for each connection an output of one stream processing object is connected to an input of another stream processing object. As used henceforth, the term “dataflow” means a sequence of functions. To produce a dataflow having a certain desired processing of the stream of data, the stream processing engine instructs a certain plurality of connections between a certain plurality of stream processing objects according to a description of the desired processing received via the stream processing engine's API.

### SUMMARY

According to at least an embodiment, a system for processing a stream of digital data comprises at least one hardware processor configured to: manage a plurality of stream processing engines having a plurality of stream processing objects; and simultaneously process the stream of digital data by the plurality of stream processing engines. The system is further configured, during the simultaneously processing the stream of digital data, to send an output of a first of the plurality of stream processing objects of a first stream processing engine of the plurality of stream processing engines to an input of a second of the plurality of stream processing objects of a second stream processing engine of the plurality of stream processing engines. Connecting stream processing objects of more than one stream processing engine enables building stream processing solutions more efficient and with richer functionality than stream processing solutions built with stream processing objects of only one stream processing engine.

According to at least an embodiment, a method for processing a stream of digital data, comprises: managing a plurality of stream processing engines, each of said plurality of stream processing engines having a plurality of stream processing objects; and simultaneously processing the stream of digital data by the plurality of stream processing engines. During the simultaneously processing the stream of digital data, sending an output of a first of the plurality of stream processing objects of a first stream processing engine of the plurality of stream processing engines to an input of a second of the plurality of stream processing objects of a second stream processing engine of the plurality of stream processing engines.

In some embodiments, the second of the plurality of stream processing objects of the second stream processing engine is a connection object, adapted to receive a second stream of digital data from the first of the plurality of stream processing engines and send the second stream of digital data to a third of the plurality of stream processing objects of the second stream processing engine, to provide connectivity between the third of the plurality of stream processing objects and the first of the plurality of stream processing engines. In some embodiments, using a connection object allows building stream processing solutions using stream processing objects that cannot receive input from outside their stream processing engine, providing a richer choice of stream processing objects when building a stream processing solution.

In some embodiments, the system is configured to manage the plurality of stream processing engines by: applying a first scoring function to each stream processing object in a list of stream processing objects of the plurality of stream processing engines to obtain a first plurality of scores; identifying a first maximal score of the first plurality of scores; selecting a first stream processing object associated with the first maximal score; and sending the stream of digital data to an input of the selected first stream processing object. In some embodiments, the system is further configured to manage a plurality of stream processing engines by: applying a second scoring function to each stream processing object of the list of stream processing objects to obtain a second plurality of scores; identifying a second maximal score of the second plurality of scores; select a second stream processing object associated with the second maximal score; and sending an output of the first processing object to an input of the second stream processing object. In some embodiments, choosing best operators according to a scoring function allows building efficient and high performance stream processing solutions.

In some embodiments, each stream processing object of the plurality of stream processing objects has a function having a plurality of values of a plurality of function properties. In some embodiments, the scoring function comprises testing the compliance of at least one of the plurality of values with a value selected from a group comprising: an identified function description; an identified output type; an identified input type; an identified amount of inputs; an identified threshold latency value; an identified threshold throughput value; an identified security policy; and an identified administrative policy.

In some embodiments, the system is further configured to: monitor at least one stream processing object to obtain at least one performance measurement value indicative of the performance of the at least one stream processing object; and instructing a re-activation of the one stream processing object or replacing the one stream processing object with a third stream processing object from the list of stream processing objects, if the at least one performance measurement value is above or below a threshold performance value. Replacing or instructing a re-activation of a faulty stream processing operator allows building fault tolerant stream processing solutions.

In some embodiments, the system is configured to send an output via a digital network connection. Using a digital network connection allows connecting stream processing engines executed on different hardware processors.

In some embodiments, the system is configured to send an output via network buffers.

In some embodiments, the system is configured to send an output via shared memory, message passing or message queuing.

In some embodiments, the system further comprises a non-volatile digital storage connected to the at least one hardware processor. In some embodiments, the system is further configured to store a description of the system in the non-volatile digital storage. In some embodiments, the non-volatile digital storage comprises a database. In some embodiments, the description comprises at least one of a group including: a description of a plurality of stream processing engines, comprising for each stream processing engine a list of stream processing objects; a description of a plurality of stream processing objects, comprising for each stream processing object the plurality of values of the plurality of function properties; a plurality of values of a plurality of function properties; and a description of a connection between the first of the plurality of stream processing objects and the second of the plurality of stream processing objects comprising an identification of the first of the plurality of stream processing objects and the second of the plurality of stream processing objects. In some embodiments, storing a system description in non-volatile digital memory allows recovery of a previously built system.

According to at least an embodiment, a computer program product comprising instructions is provided, which when the program is executed by a computer, cause the computer to carry out the steps of the method of claim 14.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the embodiment of the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

To describe the technical solutions in the embodiments of this application more clearly, the following briefly describes the accompanying drawings required for describing the embodiments. Apparently, the accompanying drawings in the following description show merely some embodiments recorded in this application, and a person of ordinary skill in the art may still derive other drawings from these accompanying drawings. One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic illustration of an exemplary mapping of a dataflow to a plurality of stream operators in a plurality of stream engines, according to a solution of some approaches for stream processing;

FIG. 2 is a schematic illustration of an exemplary system according to at least an embodiment of the present disclosure;

FIG. 3 is a flowchart schematically representing a flow of operations for processing a stream of data, according to at least an embodiment of the present disclosure;

FIG. 4 is a flowchart schematically representing a flow of operations with regard to selecting a first stream operator of a dataflow, according to at least one embodiment of the present disclosure;

FIG. 5 is a flowchart schematically representing a flow of operations with regard to selecting an additional stream operator of a dataflow, according to at least one embodiment of the present disclosure;

FIG. 6 is a schematic illustration of an exemplary mapping of a dataflow to a plurality of stream operators in a plurality of stream engines, according to at least one embodiment of the present disclosure; and

FIG. 7 is a flowchart schematically representing a fourth optional flow of operations with regard to recovering from a failure, according to at least one embodiment of the present disclosure.

### DETAILED DESCRIPTION

Hereinafter, at least one embodiment of the present disclosure will be described in detail with reference to the accompanying drawings. However, it is understood that the following description is not limiting, and specific objectives, technical solutions, and/or advantages may be described below to simplify the present disclosure, and are not limiting.

The present disclosure, in some embodiments thereof, relates to a system for processing a stream of data. In some embodiments, the present disclosure includes distributed processing of data in big data systems.

As used henceforth, the term “stream engine” means “stream processing engine”, and the term “stream operator” means “stream processing object”.

A stream engine of some approaches has an API for describing a desired processing of a stream of data. In some approaches, different stream engines have different APIs. A stream engine of some approaches converts a description of a desired processing to a logical representation of the desired processing, and the logical representation is then mapped to an execution plan. A stream engine of some approaches maps the execution plan to an execution framework in the stream engine, and instructs a plurality of connections between a plurality of its stream operators to produce a dataflow having the desired processing of the stream of data.

A stream operator of some approaches has a function, having a plurality of values of a plurality of function properties. Examples of function properties are a number of inputs, a type of an input, a description of an input, a type of an output, a latency of the stream operator and a throughput of the stream operator.

A stream engine of some approaches manages only connections between its own stream operators. In a system of some approaches having more than one stream engine, one of the more than one stream engines cannot instruct a connection between an output of one of its own stream operators and an input of another stream operator of another of the more than one stream engines. However, there may be a need to create such a connection between stream operators of more than one stream engine. For example, there may be a desired processing of a stream of data having a plurality of functions. There may be one stream engine having some, but not all, of the plurality of functions. There may be a second stream engine having some other of the plurality of functions which the one stream engine does not have. For example, one stream engine may have one or more stream objects for mapping stream data, but no stream objects for processing a window of data (that is data having a certain property with a value within certain finite boundaries), whereas a second stream engine may have at least one stream object for processing a window of data but no stream objects for mapping stream data. Stream processing of some approaches that requires both mapping stream data and processing a window of data cannot be achieved using only one of these two stream engines. In such a case, there is a need to use stream operators from both stream engines to produce the desired processing of the stream of data.

In addition, there may be two or more stream engines, each having a stream operator having a certain function. However, two stream operators from two different stream engines of the two or more stream engines may have different certain values for the same certain function property of the certain function. It may be that for some functions the one of the two or more stream engines has some stream operators with some preferable values of a certain function property, and that for some other functions the second of the two or more stream engines has some other stream operators with some other preferable values of the certain function property. To produce an optimal stream processing solution, it may be needed to use a plurality of stream objects from at least two of the two or more stream engines.

For example, the one of the two or more stream engines may have a stream operator having the certain function having a first latency value, while the second of the two or more stream engines may have a stream operator having the certain function having a second latency value, the second latency value being different from the first latency value. To produce a lowest latency solution, there may be a need to use stream objects from both the one of the two or more stream engines and the second of the two or more stream engines.

Stream engine solutions of some approaches include, for example Microsoft StreamInsight, Apache Flink, Apache Spark, Apache Storm and Apache Beam, do not enable connections between individual stream objects of multiple stream engines.

In solving at least one or more of these problems, the present disclosure, in some embodiments, manages a plurality of stream objects of a plurality of stream engines, and connects between at least one stream object of one stream engine and at least one second stream object of a second stream engine. In some embodiments, connecting stream objects between different stream engines expands connectivity options and processing functions compared to using a single stream engine, and enables producing some dataflows for processing stream data not possible using a single stream engine. In addition, in some embodiments, connecting stream objects between different stream engines allows optimizing a dataflow for processing stream data, for example improving latency or improving throughput of a dataflow, compared to producing a dataflow using only stream objects of a single stream engine.

In addition, stream processing solutions of some approaches do not support dynamic correction of performance degradation or failure, and require reconfiguring an entire dataflow to overcome failure or performance degradation. The present disclosure, in some embodiments, monitors performance of at least one stream operator. Upon identifying a degradation in performance or a failure of the at least one stream operator, the present disclosure, in some embodiments, instructs a re-activation or replacement of the at least one stream operator with another stream operator. Monitoring and correcting failures, in some embodiments, allows creation of a reliable and fault tolerant stream processing system. In addition, in some embodiments, where a stream engine may be able to correct failures within the stream engine, being able to correct a failure using a stream operator from a plurality of stream engines allows reliability even in cases where an entire stream engine fails or suffers degraded performance.

The present disclosure is not necessarily limited to the details of construction and the arrangement of the components and/or methods set forth in the following description and/or illustrated in the drawings and/or the Examples. The disclosure is capable of other embodiments or of being practiced or carried out in various ways.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

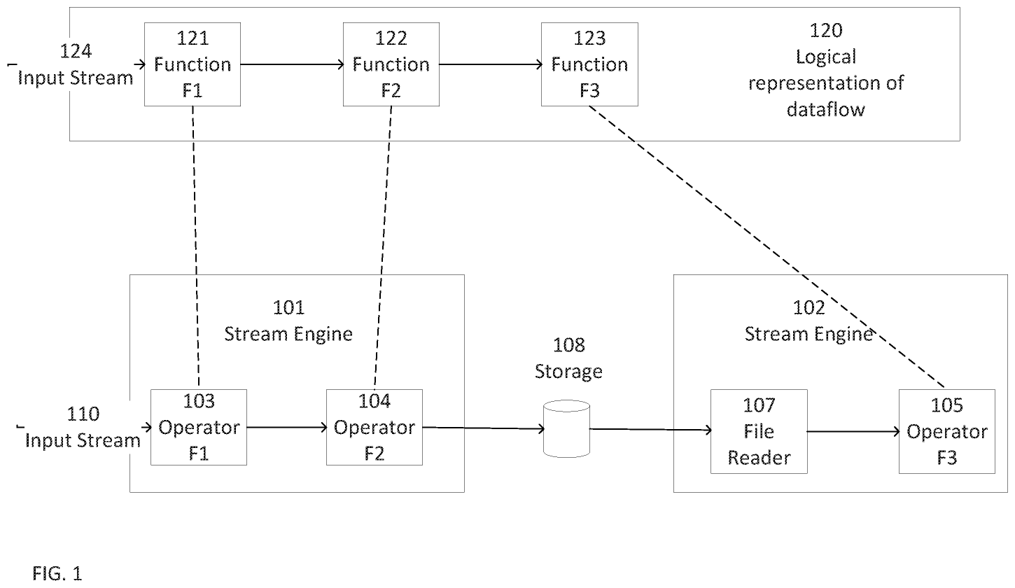

Reference is now made to FIG. 1, showing a schematic illustration of an exemplary mapping of a dataflow to a plurality of stream operators in a plurality of stream engines, according to some approaches for stream processing. A logical representation 120 of a dataflow comprises one or more functions. 121, 122 and 123 are possible functions F1, F2 and F3 respectively. In this logical representation of the dataflow, function F1 is applied to input stream 124 to produce a result. The result is sent to function F2. A second result, produced by applying function F2 to function F2's input, is sent to function F3. In some solutions, a stream engine 101 has stream operators 103 and 104 having functions F1 and F2 respectively, but no stream operator having function F3. In such solutions, stream engine 102 has a stream operator 105 having function F3. Logical representation 120 cannot be realized using only stream engine 101 or only stream engine 102. In such a mapping, function 121 is mapped to operator 103, function 122 to operator 104 and function 123 to operator 105. An input stream 110 is received by operator 103. In such solutions, an output of operator 104 cannot be connected directly to an input of operator 105. An additional component, for example a nonvolatile digital storage 108 is used in such solutions to connect between stream engines 101 and 102. An output of operator 104 is connected to the non-volatile digital storage and operator 104 sends result data on the output to the non-volatile digital storage. In such solutions stream engine 102 has a connection object, for example a file reader software object 107, for reading the result data from the non-volatile digital storage and sending the result data to an input of operator 105.

Requiring an additional component such as a non-volatile digital storage to connect between a plurality of stream engines increases the cost of implementing a solution and reduces the performance of the solution by introducing latencies, for example due to writing to and reading from a non-volatile digital storage. In addition, such an addition breaks continuous processing of the stream of data. The present disclosure, in some embodiments thereof, allows connecting between a plurality of stream engines without using additional components.

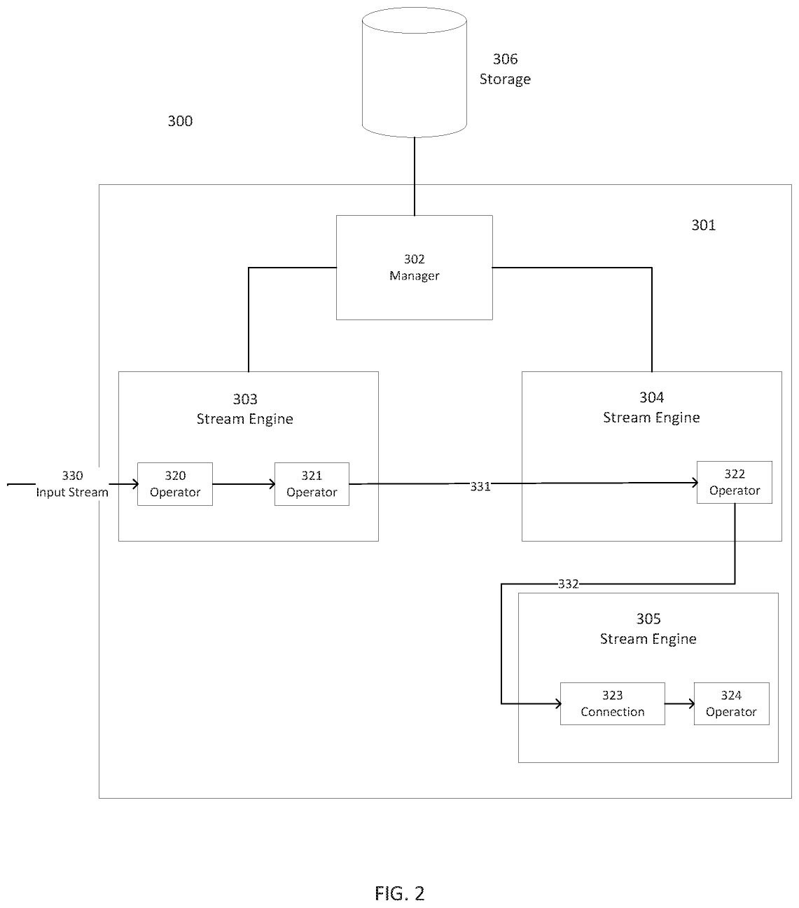

Reference is now also made to FIG. 2 showing a schematic illustration of an exemplary system 300 for processing a stream of data according to at least one embodiment of the present disclosure. In some embodiments, at least one hardware processor 301 executes a code for managing a plurality of stream engines, for example 303, 304 and 305. Optionally the code comprises a manager 302. The manager is a software object comprising code for managing the plurality of stream engines. The manager optionally comprises an API for describing a desired processing of a stream of data. A system administrator may use the API to describe a desired processing of a stream of data. In these embodiments each of the plurality of stream engines has a plurality of stream operators for processing a stream of data. For example, stream engine 303 may have stream operators 320 and 321; stream engine 304 may have stream operator 322; and stream engine 305 may have stream operators 323 and 324. Optionally, the manager converts a description of a desired processing to a logical representation of the desired processing; the logical representation is then mapped to an execution plan using some of the plurality of stream operators of some of the plurality of stream engines. For example, in a possible execution plan an input stream 330 is received by a stream operator 320 of one of the plurality of stream engines. In this execution plan an output of stream operator 321 of stream engine 303 is connected 331 to an input of stream operator 322 of stream engine 304. Optionally, connection 331 uses shared memory of the at least one hardware processor. Optionally, connection 331 uses message passing, for example using Message Passing Interface (MPI). Optionally, connection 331 uses message queuing, for example Advanced Message Queuing Protocol (AMQP) and Streaming Text Oriented Message Protocol (STOMP). In some embodiments where stream engine 303 and stream engine 304 are executed by separate hardware processors of the at least one hardware processor, connection 331 is via a digital network connection, for example an Internet Protocol based network connection. In some such embodiments having a digital network connection, connection 331 uses network buffers.

In some embodiments, the system 300 comprises a non-volatile digital storage 306. Optionally the manager stores a description of the system in the non-volatile digital storage. The description of the system may comprise at least one of a group including: a description of a plurality of stream engines, comprising for each stream processing engine a list of stream processing objects; a description of a plurality of stream operators, comprising for each stream processing object a plurality of values of a plurality of function properties; a plurality of values of a plurality of function properties; and a description of a connection between one stream operator of the plurality of stream operators and another stream operator of the plurality of stream operators. Optionally, the description of the connection comprises an identification of the one stream operator and another stream operator. Optionally, the description of the connection comprises an Internet Protocol port, a protocol identifier and/or an endpoint identifier. Optionally, the description of a stream processing object comprises benchmark performance values of one or more functions of the stream processing object. Optionally, the non-volatile digital storage comprises a database.

A stream operator of the plurality of stream operators of a stream engine of the plurality of stream engines may not be adapted to receive input from another stream operator of a different stream engine of the plurality of stream engines. In some embodiments, stream engine 305 comprises a connection software object 323, adapted to receive input 332 from stream operator 322 of stream engine 304. In such embodiments, the connection software object is adapted to send data received on 332 to stream operator 324 of stream engine 304. In such embodiments, stream engine 304 and stream engine 305 are not the same stream engine.

To provide the solution, the system implements the following method.

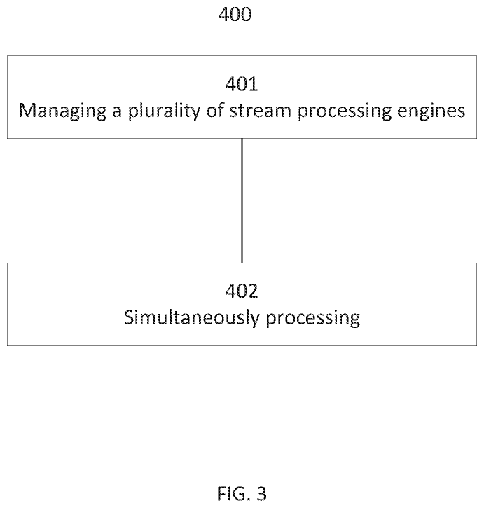

Reference is now also made to FIG. 3, showing a flowchart schematically representing a flow of operations 400 for processing a stream of data, according to at least one embodiment of the present disclosure. In some embodiments, the hardware processor(s) manages 401 a plurality of stream engines for processing one or more streams of digital data; each of the stream engines has a plurality of stream operators (i.e., stream processing objects) for processing one or more streams of digital data. Managing the plurality of stream engines may comprise selecting a first stream operator. Optionally the manager selects the first stream operator.

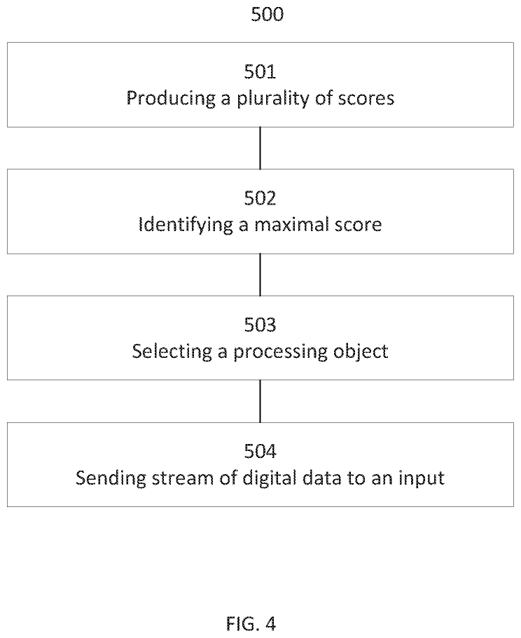

Reference is now also made to FIG. 4, showing a flowchart schematically representing a second optional flow of operations 500 with regard to selecting a first stream operator, according to at least one embodiment of the present disclosure. In these embodiments, the hardware processor(s) produces 501 a plurality of scores, by applying a first scoring function to each stream processing object (i.e., stream operator) in a list of stream processing objects (i.e., stream operators) comprising the plurality of stream operators of the plurality of stream engines. Optionally, each stream operator of the plurality of stream operators has a plurality of values of a plurality of function properties. Examples of function properties are a function description, an output type, an input type, an amount of inputs, a latency value, of throughput value, a security police and an administrative policy. Optionally the first scoring function comprises testing the compliance of at least one of the plurality of values with a value selected from a group comprising: an identified function description, an identified output type, an identified input type, an identified amount of inputs, an identified threshold latency value, an identified threshold throughput value, an identified security policy, and an identified administrative policy. For example, a scoring function may comprise testing the compliance of a latency value with an identified latency threshold. An example of a latency threshold is a number of milliseconds, such as 5 milliseconds or 17 milliseconds.

In 502, the hardware processor(s) identifies a maximal score of the plurality of scores, and selects 503 a stream operator associated with the identified maximal score. In these embodiments, the at least one hardware processor sends the stream of digital data to an input of the selected stream operator.

After selecting a first stream operator, managing the plurality of stream engines may in addition comprise selecting at least one additional stream operator. Optionally the manager selects the at least one additional stream operator.

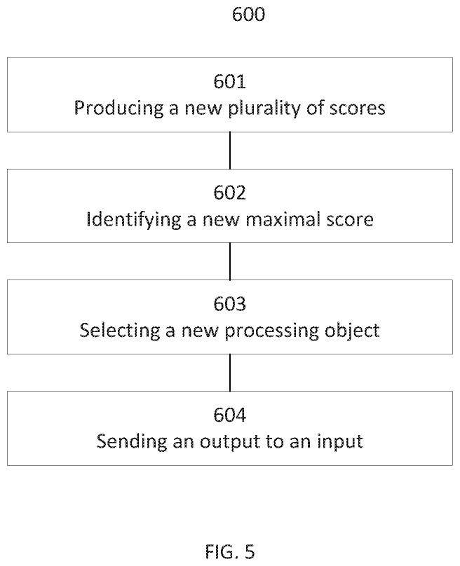

Reference is now also made to FIG. 5, showing a flowchart schematically representing a third flow of operations 600 with regard to selecting an additional stream operator of a dataflow, according to at least one embodiment of the present disclosure. In these embodiments, the hardware processor(s) produces 601 a new plurality of scores, by applying a new scoring function to each stream operator of the list of stream operators. Optionally, the new scoring function comprises testing the compliance of at least one of the plurality of values with a value selected from a group comprising: an identified function description, an identified output type, an identified input type, an identified amount of inputs, an identified threshold latency value, an identified threshold throughput value, an identified security policy, and an identified administrative policy. For example, a new scoring function may comprise testing the compliance of a throughput value with an identified throughput value. An example of a throughput threshold is a number of kilobytes per second (kbps), such as 100 kbps or 2048 kbps.

In 602, the hardware processor(s) identifies a new maximal score of the new plurality of scores, and selects 603 a new stream operator associated with the identified new maximal score. In these embodiments, the at least one hardware processor sends 604 an output of a previously selected stream operator to an input of the selected new stream operator.

Reference is now made again to FIG. 3. After selecting a set of stream operators from a list of stream operators comprising the plurality of stream operators of the plurality of stream engines, the hardware processor(s) simultaneously processes 402 a stream of digital data by the plurality of stream processing engines. Optionally, during the simultaneously processing a stream of digital data, the hardware processor(s) sends an output of a first of the plurality of stream operators of a first stream engine of the plurality of stream engines to an input of a second of the plurality of stream operators of a second stream engine of the plurality of stream. For example, the hardware processor(s) sends an output of the first selected stream operator to an input of the new selected stream operator.

The present disclosure, in some embodiments thereof, provides a solution to realizing an execution plan of a desired stream processing using stream operators of a plurality of stream engines without requiring an additional component.

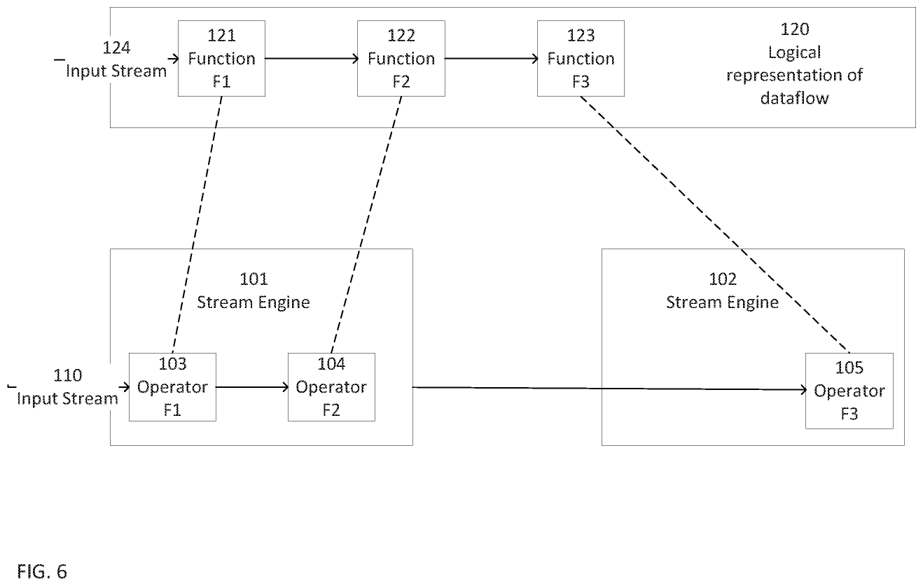

Reference is now also made to FIG. 6, showing a schematic illustration of an exemplary mapping of a dataflow to an execution plan comprising a plurality of stream operators in a plurality of stream engines, according to at least one some embodiment of the present disclosure. In these embodiments, such mappings, an output of operator 104 is connected directly to an input of operator 105, without the need to use a non-volatile digital storage.

The present disclosure, in some embodiments, enables producing a fault tolerant solution for processing a stream of digital data. In some embodiments, to provide the fault tolerant solution, the system further implements the following method.

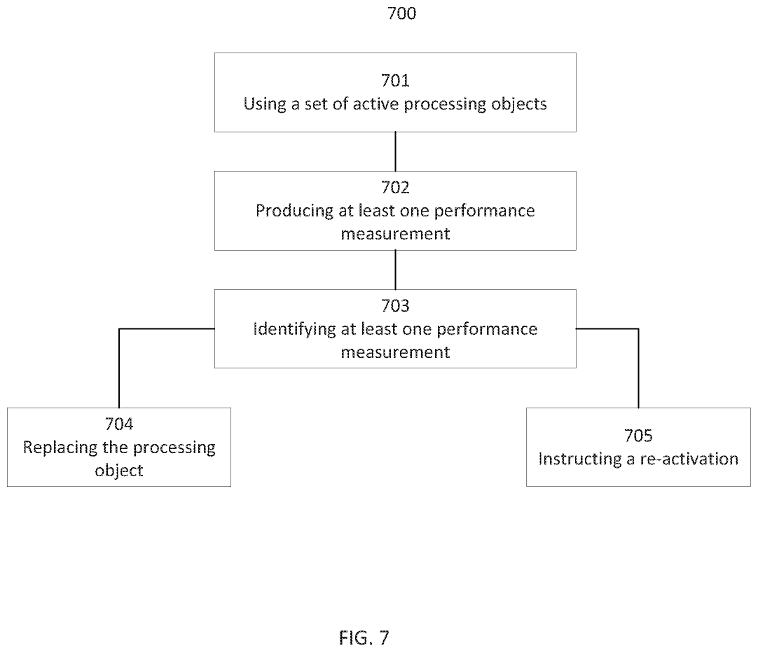

Reference is now also made to FIG. 7, showing a flowchart schematically representing a fourth optional flow of operations 700 with regard to recovering from a failure, according to at least one embodiment of the present disclosure. In these embodiments, the hardware processor(s) uses 701 a set of active stream operators comprising the selected stream operator and the selected new stream operator. Optionally, in 702 the hardware processor(s) produces at least one performance measurement value by monitoring performance metrics of one stream operator of a set of active stream operators. An active stream operator is a stream operator selected while managing the plurality of stream engines for processing a stream of digital data. An example of a performance metric is throughput, and an example of a performance measurement value is a throughput value. Another example of a performance metric is latency, and another example of a performance measurement value is a latency value. Optionally, in 703 the hardware processor(s) identifies that a performance problem exists. A performance problem includes at least one of a group comprising: a failure of the one stream operator, a decrease in a throughput of the one stream operator and an increase in a latency of the one stream operator. The hardware processor(s) may identify that a performance problem exists by comparing between the at least one performance measurement value and a threshold performance value. Optionally, a performance problem is identified when the at least one performance measurement value is above the threshold performance value. Optionally, a performance problem is identified when the at least one performance measurement value is below the threshold performance value. In some embodiments, upon identifying that a performance problem exists, the at least one hardware processor replaces 704 the one stream operator with a third stream operator from the list of processing operators. In other embodiments, upon identifying that a performance problem exists, the at least one hardware processor instructs 705 a re-activation of the one stream operator.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

It is expected that during the life of a patent maturing from this application relevant stream engines and stream operators will be developed and the scope of the terms “stream engine” and “stream operator” in the present disclosure include new technologies a priori.

As used herein the term “about” refers to within 10%.

The terms “comprises”, “comprising”, “includes”, “including”, “having” and their conjugates mean “including but not limited to”.

The phrase “consisting essentially of” means that the composition or method may include additional ingredients and/or steps, if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features, unless such features conflict.

Throughout the present disclosure, various embodiments may be presented in a range format. It should be understood that the description in range format is at least for convenience or brevity, and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, or the like, as well as individual numbers within that range, for example, 1, 2, 3, 4, 5, and 6. This applies regardless of the breadth of the range.

When a numerical range is indicated herein, the numerical range includes any cited numeral (fractional or integral) within the indicated range. The phrases “ranging/ranges between” a first indicate number and a second indicate number and “ranging/ranges from” a first indicate number “to” a second indicate number are used herein interchangeably and include the first and second indicated numbers and all the fractional and integral numerals there between.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A method for processing a stream of digital data, comprising:
managing, by a processor, a plurality of stream processing engines, each of said plurality of stream processing engines having a plurality of stream processing objects; and
simultaneously processing said stream of digital data by said plurality of stream processing engines;
wherein said simultaneously processing said stream of digital data comprises:
sending an output of a first stream processing object of said plurality of stream processing objects of a first stream processing engine of said plurality of stream processing engines to an input of a second stream processing object of said plurality of stream processing objects of a second stream processing engine of said plurality of stream processing engines.

2. A computer program product, comprising non-transitory computer readable storage medium containing instructions therein which, when executed by a processor, cause the processor to:
manage a plurality of stream processing engines, each of said plurality of stream processing engines having a plurality of stream processing objects; and
simultaneously process said stream of digital data by said plurality of stream processing engines;
wherein said simultaneously processing said stream of digital data comprises:
send an output of a first stream processing object of said plurality of stream processing objects of a first stream processing engine of said plurality of stream processing engines to an input of a second stream processing object of said plurality of stream processing objects of a second stream processing engine of said plurality of stream processing engines.

3. A device for processing a stream of digital data, comprising:
a memory configured to store executable instructions; and
at least one processor coupled to the memory, and configured to execute the instructions to:
manage a plurality of stream processing engines, each of said plurality of stream processing engines having a plurality of stream processing objects; and
simultaneously process said stream of digital data by said plurality of stream processing engines; and
simultaneously process said stream of digital data by sending an output of a first stream processing object of said plurality of stream processing objects of a first stream processing engine of said plurality of stream processing engines to an input of a second stream processing object of said plurality of stream processing objects of a second stream processing engine of said plurality of stream processing engines.

4. The device of claim 3, wherein
said second stream processing object of said plurality of stream processing objects of said second stream processing engine of said plurality of stream processing engines is a connection object,
said at least one processor is further configured to execute the instructions to:
receive a second stream of digital data from said first stream processing engine of said plurality of stream processing engines, and
send said second stream of digital data to a third stream processing object of said plurality of stream processing objects of said second stream processing engine of said plurality of stream processing engines, to provide connectivity between said third stream processing object of said plurality of stream processing objects and said first stream processing engine of said plurality of stream processing engines.

5. The device of claim 4, wherein said at least one processor configured to execute the instructions to manage the plurality of stream processing engines comprises:
applying a first scoring function to each stream processing object in a list of stream processing objects of said plurality of stream processing engines, to obtain a first plurality of scores;
identifying a first maximal score of said first plurality of scores;
selecting said first stream processing object associated with said first maximal score; and
sending said stream of digital data to an input of said selected first stream processing object.

6. The device of claim 5, wherein said at least one processor is further configured to execute the instructions to manage the plurality of stream processing engines further comprises:
applying a second scoring function to each stream processing object in said list of stream processing objects of said plurality of stream processing engines, to obtain a second plurality of scores;
identifying a second maximal score of said second plurality of scores;
selecting said second stream processing object associated with said second maximal score; and
sending an output of said first stream processing object to an input of said second stream processing object.

7. The device of claim 5, wherein each stream processing object of said plurality of stream processing objects has a function having a plurality of values of a plurality of function properties; and
wherein said first scoring function comprises testing the compliance of at least one of said plurality of values with a value selected from at least:
an identified function description;
an identified output type;
an identified input type;
an identified amount of inputs;
an identified threshold latency value;
an identified threshold throughput value;
an identified security policy; or
an identified administrative policy.

8. The device of claim 5, wherein said at least one processor is further configured to execute the instructions to:
monitor at least one stream processing object thereby obtaining at least one performance measurement value indicative of a performance of the at least one stream processing object; and
replace said at least one stream processing object with said third stream processing object from the list of stream processing objects, if said at least one performance measurement value is above or below a threshold performance value.

9. The device of claim 5, wherein said at least one processor is further configured to execute the instructions to:
monitor at least one stream processing object thereby obtaining at least one performance measurement value indicative of a performance of the at least one stream processing object; and
instruct a re-activation of said at least one stream processing object, if said at least one performance measurement value is above or below a threshold performance value.

10. The device of claim 3, wherein said at least one processor is further configured to execute the instructions to send an output via a digital network connection.

11. The device of claim 3, wherein said at least one processor is further configured to execute the instructions to send an output via network buffers.

12. The device of claim 10, wherein said at least one processor is further configured to execute the instructions to send an output via shared memory, message passing or memory queuing.

13. The device of claim 3, further comprising:
a non-volatile digital storage medium connected to said at least one hardware processor; and
wherein said at least one processor is further configured to store said executable instructions in said non-volatile digital storage medium.

14. The device of claim 13, wherein said instructions comprise at least:
a description of said plurality of stream processing engines, comprising:
for each stream processing engine, a list of stream processing objects;
a description of said plurality of stream processing objects, comprising:
for each stream processing object, a plurality of values of a plurality of function properties;
said plurality of values of said plurality of function properties; or
a description of a connection between said first stream processing object of said plurality of stream processing objects and said second stream processing object of said plurality of stream processing objects comprising an identification of said first stream processing object of said plurality of stream processing objects and said second stream processing objects of said plurality of stream processing objects.

15. The device of claim 13 wherein said non-volatile digital storage medium comprises a database.

16. The method of claim 1, wherein
said second stream processing object of said plurality of stream processing objects of said second stream processing engine of said plurality of stream processing engines is a connection object,
said method further comprises:
receiving a second stream of digital data from said first stream processing engine of said plurality of stream processing engines, and
sending said second stream of digital data to a third stream processing object of said plurality of stream processing objects of said second stream processing engine of said plurality of stream processing engines, to provide connectivity between said third stream processing object of said plurality of stream processing objects and said first stream processing engine of said plurality of stream processing engines.

17. The method of claim 16, further comprising:
applying a first scoring function to each stream processing object in a list of stream processing objects of said plurality of stream processing engines, to obtain a first plurality of scores;
identifying a first maximal score of said first plurality of scores;
selecting said first stream processing object associated with said first maximal score; and
sending said stream of digital data to an input of said selected first stream processing object.

18. The method of claim 17, further comprising:
applying a second scoring function to each stream processing object in said list of stream processing objects of said plurality of stream processing engines, to obtain a second plurality of scores;
identifying a second maximal score of said second plurality of scores;
selecting said second stream processing object associated with said second maximal score; and
sending an output of said first stream processing object to an input of said second stream processing object.

19. The method of claim 17, wherein each stream processing object of said plurality of stream processing objects has a function having a plurality of values of a plurality of function properties; and
wherein said first scoring function comprises testing the compliance of at least one of said plurality of values with a value selected from at least:
an identified function description;
an identified output type;
an identified input type;
an identified amount of inputs;
an identified threshold latency value;
an identified threshold throughput value;
an identified security policy; or
an identified administrative policy.

20. The method of claim 17, further comprising:
monitoring at least one stream processing object thereby obtaining at least one performance measurement value indicative of a performance of the at least one stream processing object; and
replacing said at least one stream processing object with said third stream processing object from the list of stream processing objects, if said at least one performance measurement value is above or below a threshold performance value.
